(19) United States
(12) Patent Application Publication
(10) Pub. No.: US 2012/0265715 A1
(43) Pub. Date: Oct. 18, 2012

(54) FACILITATED METHOD TO IMPROVE PROFESSIONAL RELATIONSHIPS

(76) Inventor: Seth Silver, Rochester, NY (US)

(21) Appl. No.: 13/451,157

(22) Filed: Apr. 19, 2012

Related U.S. Application Data
(63) Continuation-in-part of application No. 11/614,886, filed on Dec. 21, 2006, now abandoned.

(51) Int. Cl. G06Q 90/00

(52) U.S. Cl. 705/500

(57) ABSTRACT

A behavioral contracting method wherein two parties openly discuss their obligations to and expectations of the other party to form ratified explicit document containing all the obligations the parties have to each other.

### CROSS-REFERENCED TO RELATED APPLICATIONS

This application is a continuation-in-part of U.S. patent application Ser. No. 11/614,886, filed Dec. 21, 2006 and entitled FACILITATED METHOD TO IMPROVE PROFESSIONAL RELATIONSHIPS, the specification of which hereby incorporated by reference in its entirety.

### FIELD OF THE INVENTION

This invention relates to a behavioral contracting method to improve the relationship between two distinct groups of professionals.

### BACKGROUND OF THE INVENTION

In a professional relationship the difference between what one party expects and another party views as obligated to perform can differ greatly. These expectations and obligations are generally implicit and rarely ever discussed in detail between the parties. Because the obligations and expectations are not communicated, neither party may be aware of what is expected from the other party. These implicit expectations go unexpressed, and therefore, can become unmet resulting in negative relationship characteristics.

In today's workplace there is an increasing focus on relationships with external customers. However, rarely is there an inquiry about relationships within the workplace. Customer satisfaction and loyalty is related to employee satisfaction and loyalty. Therefore, by increasing workplace relationships, organizations can improve their customer loyalty.

There exists a need for a constructive process that enables all parties to identify their perception of their obligations to the other party and their expectations of the other party. The process further allowing for all parties to engage in a safe, routine and non-adversarial review of the relationship.

Furthermore, there is a need for a constructive process that provides a structured approach in which all parties feel equal, that they have been heard, and are respected throughout the process. The process shall provide a channel in which the parties can review the terms of their relationship without embarrassment or retribution.

### SUMMARY OF THE INVENTION

The present invention provides a facilitated, structured and non-adversarial process to enable any professional relationship to start off, and stay, on a positive, open and mutually beneficial path. The method is designed to enhance empathy, respect, trust, alignment and partnership between two parties.

The invention comprises a facilitated process in which a plurality of parties document their obligations to and expectations of another party. The parties then merge non-covered expectations into the other party's list of obligations to form covenants. The covenants are later ratified. By explicitly documenting the obligations of a party that party's responsibilities become clear.

The method involves both parties during the process. That is, the manager and the staff are both a part of this process and are regarded as equals in the dialogue and the pursuant commitments. This is distinct from interventions that only address the manager's behavior, while not specifically addressing the team's behavior or their role in the relationship.

The method goes beyond merely obvious conversation about respective roles and obligations. In a logical, step-by-step process, it moves the two parties from identification of respective obligations/expectations, through the exchange of feedback, to the negotiation of future commitments, to the signing of behavioral contracts (i.e. covenants), to the everyday use of these contracts, and finally to the routine practice of formal review as a team. In other words, this is not just a ‘casual chat’ about team relations, but rather a structured approach to building workplace relationships which builds off of the established fields/disciplines of social psychology, leadership theory, empowerment research, behavioral contracting, rational emotive therapy, negotiation theory, and workplace engagement.

An advantage of the present invention is that the implicit obligations of a party become explicit in a ratified document that can be posted and reviewed. A further advantage of the present invention is that all of the parties involved in the professional relationship have an opportunity to provide their expectations of another party. An effective negotiation can than take place and the obligations of the parties are documented explicitly, and ratified.

### BRIEF DESCRIPTION OF THE DRAWINGS

The present invention is disclosed with reference to the accompanying drawings, wherein:

FIG. 1 is a diagram of a process to improve professional relationships according to the present invention;

FIG. 2 is a diagram of an additional phase of a process to improve professional relationships according to the present invention; and

Corresponding reference characters indicate corresponding parts throughout the several views. The example set out herein illustrates one embodiment of the invention but should not be construed as limiting the scope of the invention in any manner.

### DETAILED DESCRIPTION

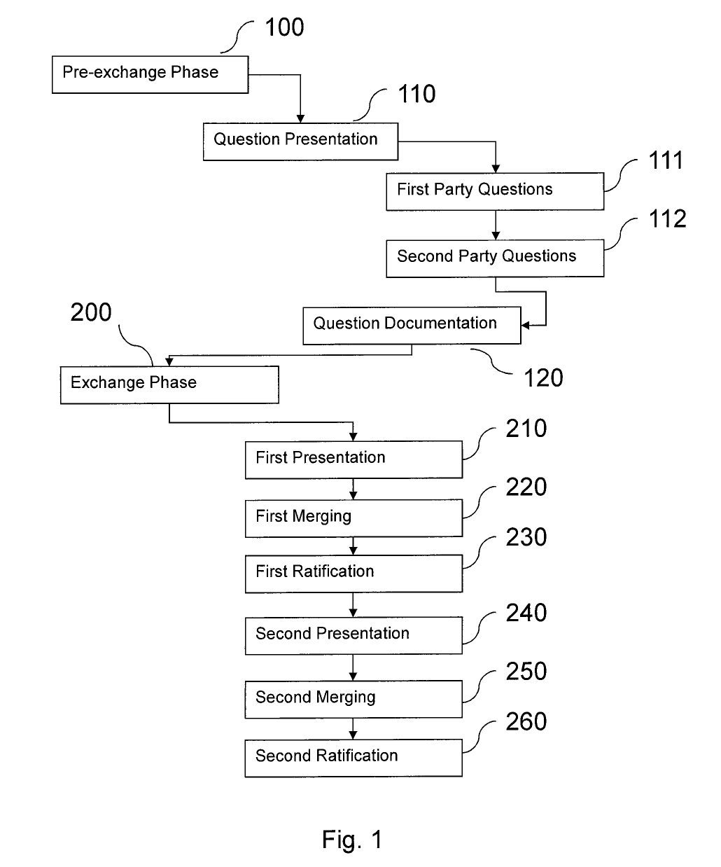

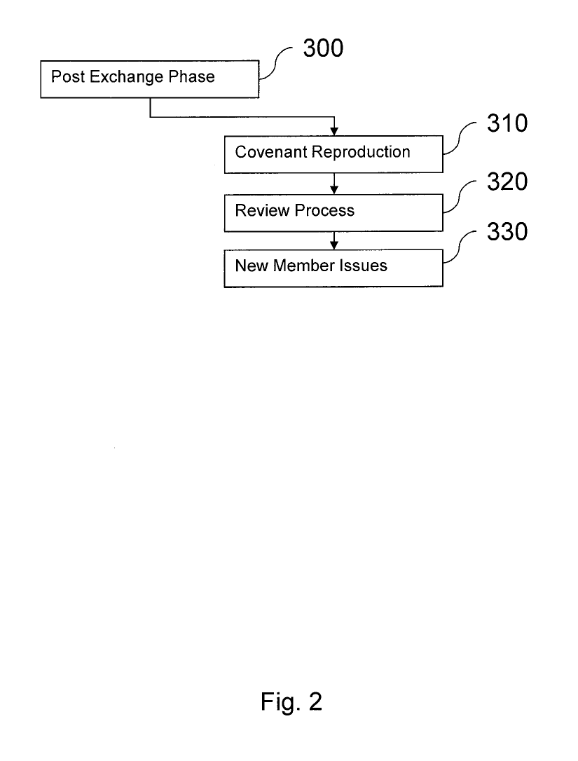

FIGS. 1 through 2 show diagrams of a process to improve professional relationships according to the present invention. The process begins with a pre-exchange phase 100 followed by an exchange phase 200 that may, in one embodiment, be followed by a post-exchange phase 300. Upon completion of the process, ratified documents outline each parties obligations to the other party. Although the process is described as improving the professional relationship between a first party and a second party, it is understood that the process may be utilized between any number of parties. The parties may be a single person or a plurality of people having the same or similar relationship to the other party. Furthermore, it is understood that although the process is described as being managed by a facilitator, the presence of a facilitator is not a requirement in all embodiments.

During the pre-exchange phase 100 a first party, a second party and a facilitator are gathered in a common space. The pre-exchange phase 100 consists of a question presentation phase 110 in which the facilitator outlines the questions to be answered by the parties. During the question presentation phase 110 a facilitator presents the first party with first recording media and a set of first party questions 111. The facilitator instructs the first party to document the answers to a first party obligation question and a first party expectation question on the first recording media, the first party obligation question being directed to providing a plurality of documented responses of the first party's obligation to the second party, the first party expectation question being directed to providing a plurality of documented responses of the first party's expectations of the second party. In addition the first party questions 111 may also include, but is not limited to, questions relating to: how well the first party is performing on each individual obligation; how well the second party is performing on each individual expectation; and any advice that can improve the relationship between the first party and the second party. The facilitator may then provide sample answers to each of the first party questions 111.

Also during the question presentation phase 110 the facilitator presents the second party with a second recording media and a set of second party questions 112. The facilitator instructs the second party to document the answers to a second party obligation question and a second party expectation question on the second recording media, the second party obligation question being directed to providing a plurality of documented responses of the second party's obligations to the first party, the second party expectation question being directed to providing a plurality of documented responses of the second party's expectations of the first party. The second party questions 112 may also include, but is not limited to, questions relating to: how well the second party is performing on each individual obligation; how well the first party is performing on each individual expectation; and any advice that can improve the relationship between the first party and the second party. The facilitator may then provide sample answers to each of the second party questions 112.

During the pre-exchange phase 100 the facilitator outlines how each party will document their answers to the questions described in the question presentation phase 110 for the documentation phase 120. At least one of the parties relocates to a location physically separate from the other party to document their answers to the question presentation phase 110. The location can be a distinct room or a separate space within the same room. Each party then documents their answer to each of the questions from the questions presentation phase 110 on a separate recording media in such a manner that the answers to particular questions may remain concealed, while at the same time the answers to other questions are disclosed. The recording media can be, but is not limited to, flipchart pages, white board areas, chalk board areas, digital pages, slides, pieces of paper, grid areas or any other form which can conceal the answers to at least one of the questions while revealing the answers to another question. In one embodiment, a flipchart is utilized and the answers to each question are documented on a distinct page of that flipchart. Additionally, recording media may be supplied with generic information such as headings already filled in. In one embodiment, a flipchart is used with the questions provided by the facilitator pre-printed on the flipchart pages, a separate page for each question. For answers in list form it is beneficial to number each answer.

Additionally, each party's obligation list should contain more entries than that party's expectation list. In one embodiment each party provides between 5 and 7 obligations and between 4 and 6 expectations. When evaluating the obligation and expectation lists an indicator next to each answer is sufficient to rate each individual obligation or expectation. Indicators may include: check marks, up arrows, down arrows, plus signs, minus signs, X's, numeric representations, or any other indication that easily rates evaluation. When evaluating a party with multiple members it is useful to use the “most of us, most of the time” rule. This rule bases the evaluation on the performance of how most of the party performs the majority of the time and does not base evaluations on individual performances or isolated instances. This rule may be used by either party to evaluate either another party or itself.

During the exchange phase 200 the parties present their answers from the question documentation phase 110. During the first presentation phase 210 a first party presents their first party obligation list along with the associated evaluation. The first party may provide examples or clarification as needed. A second party then presents their second party expectation list along with the associated evaluations. The second party may provide examples or clarification as needed. After both parties present, the first merging phase 220 takes place by merging the second party expectation list into the first party obligation list to form the first party covenant. This may be accomplished in numerous ways such as asking the second party which items in the second party expectation list are already covered in the first party obligation list, and then focusing on the items that are not already covered. In one embodiment, items in the second party expectation list that are already covered in the first party obligation list are cleared, such as being deleted, struck out or otherwise indicated as no longer requiring action. The first party and the second party may then negotiate the addition of items listed on the second party expectation list that are not covered by the items on the first party obligation list. The addition of items to the first party obligation list may be as a new item or as a sub-section of a preexisting item. After assessing each item in the second party expectation list the first party covenant is formed. During the first ratification phase 230 the first party ratifies the first party covenant agreeing to all of the items contained within it.

During the second presentation phase 240 the second party presents their second party obligation list along with the associated evaluation. The second party may provide examples or clarification as needed. A first party then presents their first party expectation list along with the associated evaluations. The first party may provide examples or clarification as needed. After both parties present the second merging phase 250 takes place by merging the first party expectation list into the second party obligation list to form the second party covenant. This may be accomplished in numerous ways such as asking the first party which items in the first party expectation list are already covered in the second party obligation list, and then focusing on the items that are not already covered. The first party and the second party may then negotiate the addition of items listed on the first party expectation list that are not covered by the items on the second party obligation list. The addition of items to the second party obligation list may be as a new item or as a sub-section of a preexisting item. After assessing each item in the first party expectation list the second party covenant is formed. During the second ratification phase 260 the second party ratifies the second party covenant agreeing to all of the items contained within it. If the second party is a plurality of people, every person ratifies the second party covenant.

During the exchange phase 200, in addition to ratifying the covenants, the first and second parties can review any additional answers to questions from the question documentation phase 120 that have not yet been covered. This may include any advice on how to further improve the professional relationship, any short or long term goals that the party may have, or any other items not previously covered.

Upon the conclusion of the exchange phase 200 the parties participate in the post-exchange phase 300. During the post-exchange phase 300 the parties may discuss, in any particular order, topics relating to how best to handle future situations. Future situations include, but are not limited to, frequency of review, adding new members, review of the covenant terms, and how to evaluate compliance. During the covenant reproduction discussion 310 the parties will discuss the best method to reproduce the covenants so that they may be easily accessed and read. This may include where the covenants are posted; if they will be made into posters or packets; how they will be distributed; if they are private or public; who should have access to the covenants; or any other item relating to the reproduction of the covenants.

The parties may also discuss the review process 320 which may cover how frequently the covenants are reviewed, the process for assessing performance, if performance will be assessed as a group or as one-on-one meetings, if any additional items need to be added to the covenants if peer review is appropriate for a party that contains multiple members, or any other issues relating to reviewing the convents. The covenants can be reviewed monthly, quarterly, semi-annually, annually or at any other time period determined by the parties. Performance may be evaluated on a plus/minus rating, a sliding scale, a graded scale, such as number or letter grades, or any other evaluation system chosen by the parties.

The parties may discuss any new member issues 330 which deal with how to introduce new members of a party to the covenant. This may include how to present the covenants to the new member, if the new member is required to ratify the covenant, will new member form a new covenant, or any other issues relating to the addition of new members to a party. For example, if the new members should be allowed to sign the old convent or if they would have to wait for the next covenant formation; or if new members will be subject to the covenant as a condition to entrance into the team.

It is understood that the process has been described as improving the professional relationship between two parties and may be used to improve the professional relationship between any number of parties. It is understood that the parties may be any person, entity or group of persons in which a professional relationship exists including but not limited to; supervisors, managers, or team leaders and their team; executive teams and middle mangers; staff groups and their customers; departments that do business with each other; sales executives and their external customers; sensor level and junior level professionals; social service provider and their clients; a board of directors and their executive team; professors or teachers and their students; business owners and their staff; or any other parties in which a professional relationship may be improved.

### Example Between a Manager and a Team Supervised by the Manager:

Step 1:

A facilitator instructs the manager and team together the purpose of a method; how it enables each party to be more satisfied with the other; how it enables constructive two-way feedback; how it helps keep the professional relationship on track.

Step 2:

The facilitator presents a series of questions to each party.

The facilitator asks the manager What are 6-8 key behavioral/attitudinal obligations you have to your team? What are 5-7 key behavioral/attitudinal expectations that you have of the team?

Reviewing the Obligations, how do you think you are doing on the obligations (check mark=pretty good for most of the group most of the time; circle=could use more focus or improvement)?

Reviewing the expectations list, how do you think the team is doing, in general, on your expectations (check mark=pretty good from most of the group most of the time, i.e. not isolated incidents; circle=could use more focus or improvement)?

The facilitator asks the manager what are 1-2 items of advice to yourself to strengthen and improve the relationship? What are 1-2 items of advice you would offer the team to strengthen and improve the relationship? What are 2-3 questions you have of the staff, on the topic of how we work together?

The facilitator asks the staff/team: What are 6-8 key behavioral/attitudinal obligations they have to the supervisor/manager? What are 5-7 key behavioral/attitudinal expectations they have of their supervisor/manager?

Reviewing the obligations list, how do you think you are doing on these obligations (check mark=pretty good from most of the group most the time; circle=could use more focus or improvement)?

Reviewing the expectations list, how do you think the supervisor/manager is doing, in general, on your expectations (check mark=pretty good toward most of the group, most of the time; circle=could use more focus or improvement)?

The facilitator asks the staff/team: What are 1-2 items of advice you would offer yourself to strengthen and improve the relationship? What are 1-2 items of advice you would offer the supervisor/manager to strengthen and improve the relationship? What are 2-3 questions you have of the supervisor/manager, on the topic of how you work together?

Step 3:

The facilitator has the manager prepare responses to his/her questions, each on a separate flipchart sheet. The facilitator has the team in a different area prepare their collective responses, also using a separate flipchart sheet for each question. The facilitator gives both parties about 30-40 minutes to prepare their responses. The flipchart, while a helpful tool in this process, is just that, a tool. Presumably any method of writing whereby both parties can look at each other's work and make comparisons would be acceptable (e.g. a large chalkboard, whiteboard, Smart Board, etc.). The key is that once the Obligations and Expectations are shared and negotiated, it is the signing of the newly formed “Covenants” that is symbolic and binding. Flipcharts are particularly helpful for this purpose, but not essential.

Step 4:

The facilitator has the manager present his/her Obligation list. Then the facilitator has the team present (i.e. have a team spokesperson do it) the team's Expectation list. Questions, clarifications and examples may be included during the presentation.

The facilitator, you then review the team's Expectation list and asks the team this question after each item: Is this item essentially present somewhere on the manager's Obligation list? Is it there in spirit if not in exact words, or does it need to be added to the manager's Obligation List as a new item, because it is clearly a Team Expectation and does not now appear on the Manager's Obligation List? If the Expectation item is there on the manager's Obligation List in exact word or spirit, then simply strike it through (i.e. draw a line through it signifying it has been dealt with) on the Expectation List and move on to the next Expectation item. If it is not there, in word or spirit, and therefore needs to be added to the manager's Obligation List, ask the manager for his/her permission to add it to the Obligation List. Then actually write it verbatim on the manager's Obligation List as a new item. Once all the team's Expectation List items have been ‘addressed’ (i.e. confirmed as being already on the manager's Obligation List, or added to the Obligation as a new item), then the managers sign his/her Obligation List as a sign of acknowledgment and acceptance. This is now the Manager's Covenant to the Team.

Step 5:

The facilitator repeats step 4 with the team's Obligation List and the Manager's Expectation List. The facilitator has the team share its Obligations and the respective ratings (i.e. check mark for doing well, circles for needs improvement), one by one. Then has the manager present his/her Expectations, one by one, and the respective ratings. Again, focusing on the Expectation List, one item at a time, ask the manager if his/her Expectations are covered in the team's Obligations: in word or spirit, or does the item need to be added to the Team's Obligation List? When all of the Expectation items have been addressed (i.e. noted as already covered in the team's Obligation List, or added as appropriate), the team sign their Obligation List. This is now the Team's Covenant to the Manager.

Step 6:

The facilitator has each party review their question about the advice to themselves and to the other party; and then share the questions they have for the other party.

Step 7:

The facilitator opens a dialogue allowing the parties to agree upon how the Covenants will be used, reviewed, modified, referred to, kept in sight.

It is understood that the example provided above is an exemplary embodiment and not intended to be limiting.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A behavioral contracting method for improving professional workplace relationships comprising the steps of:
gathering a first party, a second party and a facilitator in a common space:
the facilitator presents to the first party a first recording media and presents the second party a second recording media;
the facilitator instructs the first party to document the answers to a first party obligation question and a first party expectation question on the first recording media, the first party obligation question being directed to providing a plurality of documented responses of the first party's obligation to the second party, the first party expectation question being directed to providing a plurality of documented responses of the first party's expectations of the second party;
the facilitator instructs the second party to document the answers to a second party obligation question and a second party expectation question on the second recording media, the second party obligation question being directed to providing a plurality of documented responses of the second party's obligations to the first party, the second party expectation question being directed to providing a plurality of documented responses of the second party's expectations of the first party;
the first and second party move to distinct spaces;
the first party documents a plurality of first party obligation answers on the first recording media;
the first party documents a plurality of first party expectation answers on the first recording media;
the number of first party obligation answers is less than the number of first party expectation answers;
the second party documents a plurality of second party obligation answers on the second recording media;
the second party documents a plurality of second party expectation answers on the second recording media;
the number of second party obligation answers is less than the number of second party expectation answers;
after the first party obligation answers, first party expectation answers, second party obligation answers and second party expectation answers are recording in the first and second recording media the first party, second party and facility gather in a common space;
the facilitator displays the first party obligation answers;
the facilitator displays the second party expectation answers;
for each second party expectation answer the facilitator asks the second party if the second party expectation answer is already encompassed by a first party obligation answer, if the answer is yes that second party expectation answer is cleared from the second recording media, if the answer is no that second party expectation answer is added to the first party obligation answer on the first recording media with approval from the first party and cleared from the second party recording media;
after all the second party expectation answers are cleared from the second party recording media and added to the first party obligation answers as need, a first party covenant is formed on the first recording media;
the first party ratifies the first party covenant and transfers to the second party;
the facilitator displays the second party obligation answers;
the facilitator displays the first party expectation answers;
for each first party expectation answer the facilitator asks the first party if the first party expectation answer is already encompassed by a second party obligation answer, if the answer is yes that first party expectation answer is cleared from the first recording media, if the answer is no that first party expectation answer is added to the second party obligation answer on the second recording media with approval from the second party and cleared from the first party recording media;
after all the first party expectation answers are cleared from the first party recording media and added to the second party obligation answers as need, a second party covenant is formed on the second recording media; and
the second party ratifies the second party covenant and transfers to the first party.

2. The behavioral contracting method of claim 1, wherein the first party has a supervisory role of the second party.

3. The behavioral contracting method of claim 1, wherein the first party is a one person and the second party is a plurality of people.

4. The behavioral contracting method of claim 1, wherein the first party is plurality of people and the second party is a plurality of people.

5. The behavioral contracting method of claim 1, wherein the plurality of first party obligation answers is between 5 and 7 first party obligation answers, the plurality of first party expectation answers is between 4 and 6 first party obligation answers, the second party obligation answers is between 5 and 7 second party obligation answers, the plurality of second party expectation answers is between 4 and 6 second party obligation answers.

6. The behavioral contracting method of claim 1, wherein the first and second recording media is a flip chart having at least two pages of paper.

7. The behavioral contracting method of claim 6, wherein the documented answer to the first party obligation question is on a page distinct from the documented answer to the first party expectation question.

8. The behavioral contracting method of claim 1, wherein further comprising an evaluation phase comprising the steps of:
the first party rates the second party on each item of the second party covenant;
the second party rates the first party on each item of the first party covenant.

9. The behavioral contracting method of claim 8, wherein the rating is either a positive or negative rating.

10. The behavioral contracting method of claim 1, wherein the first party and second party negotiate the addition of any expectation to the adding the obligation answers.

11. A behavioral contracting method comprising the steps of:
gathering a first party, a second party and a facilitator in a common space:
the facilitator presents to the first party a first flip chart having at least two pages and presents the second party a second flip chart having at least two pages;
the facilitator instructs the first party to document the answers to a first party obligation question and a first party expectation question on the first flip chart, the first party obligation question being directed to providing a plurality of documented responses of the first party's obligation to the second party, the first party expectation question being directed to providing a plurality of documented responses of the first party's expectations of the second party;
the facilitator instructs the second party to document the answers to a second party obligation question and a second party expectation question on the second flip chart, the second party obligation question being directed to providing a plurality of documented responses of the second party's obligations to the first party, the second party expectation question being directed to providing a plurality of documented responses of the second party's expectations of the first party;
the first and second party move to distinct spaces;
the first party documents a plurality of first party obligation answers on the first flip chart;
the first party documents a plurality of first party expectation answers on the first flip chart;
the number of first party obligation answers is less than the number of first party expectation answers;
the second party documents a plurality of second party obligation answers on the second flip chart;
the second party documents a plurality of second party expectation answers on the second flip chart;
the number of second party obligation answers is less than the number of second party expectation answers;
after the first party obligation answers, first party expectation answers, second party obligation answers and second party expectation answers are recording ion the first and second flip chart the first party, second party and facility gather in a common space;
the facilitator displays the first party obligation answers;
the facilitator displays the second party expectation answers;
for each second party expectation answer the facilitator asks the second party if the second party expectation answer is already encompassed by a first party obligation answer, if the answer is yes that second party expectation answer is cleared from the second flip chart, if the answer is no that second party expectation answer is added to the first party obligation answer on the first flip chart with approval from the first party and cleared from the second party flip chart;
after all the second party expectation answers are cleared from the second party flip chart and added to the first party obligation answers as need, a first party covenant is formed on the first flip chart;
the first party ratifies the first party covenant and transfers to the second party;
the facilitator displays the second party obligation answers;
the facilitator displays the first party expectation answers;
for each first party expectation answer the facilitator asks the first party if the first party expectation answer is already encompassed by a second party obligation answer, if the answer is yes that first party expectation answer is cleared from the first flip chart, if the answer is no that first party expectation answer is added to the second party obligation answer on the second flip chart with approval from the second party and cleared from the first party flip chart;
after all the first party expectation answers are cleared from the first party flip chart and added to the second party obligation answers as need, a second party covenant is formed on the second flip chart; and
the second party ratifies the second party covenant and transfers to the first party.

12. The behavioral contracting method of claim 11, wherein the second party is a plurality of people and each person ratifies the second party covenant.

13. The behavioral contracting method of claim 11, wherein the distinct space is two distinct rooms.

14. The behavioral contracting method of claim 11, wherein the first party has a supervisory role of the second party and the first obligations are presented prior to the second party obligations

15. The behavioral contracting method of claim 11, wherein the first party obligation question is directed to what are the 5-7 key behavioral obligations owed to the second party and the first party expectation question is directed to what are the 4-6 key behavioral expectations owed to the first party by the second party.
